(19) United States
(12) Patent Application Publication
(10) Pub. No.: US 2010/0100465 A1
(43) Pub. Date: Apr. 22, 2010

(54) TRUSTED THIRD PARTY AUTHENTICATION AND NOTARIZATION FOR EMAIL

(75) Inventors: Jean-Luc Roger Cooke, Ottawa (CA); Nicholas Blommesteijn, Ottawa (CA)

Correspondence Address: GREER, BURNS & CRAIN, 300 S WACKER DR, 25TH FLOOR, CHICAGO, IL, 60606, US

(73) Assignee: Innovapost Inc., Kanata (CA)

(21) Appl. No.: 12/253,606

(22) Filed: Oct. 17, 2008

(51) Int. Cl. G06Q 30/00; H04L 9/00; G06F 12/14; H04L 9/32

(52) U.S. Cl. 705/34; 713/155; 726/24; 726/5

(57) ABSTRACT

A system and method for providing trustworthy processing of electronic messages applies the digital signature of a trusted third party to a message en route from the sender to a recipient. The signature is preferably applied, so that it is compliant with the S/MIME standard. The use of a trusted third party applying the digital signature allows for simplified timestamping of the message and reduces the complexity of verification of the authenticity of an archived message.

### FIELD OF THE INVENTION

This invention relates generally to the use of a trusted third party to provide authentication of message integrity and non-repudiation.

### BACKGROUND OF THE INVENTION

Electronic mail (email) has become a ubiquitous form of communication between a variety of parties. Email is favored for its low cost and rapid delivery, which many people see as a benefit and advantage over traditional mail services.

Multipurpose Internet Mail Extension (MIME) is a standard that defines how content such as text and non-text attachments are formatted. It should be noted that although MIME defines how the data is structured and formatted, it is the Simple Mail Transfer Protocol (SMTP) that defines how email is sent to a server, and how it is sent between servers. SMTP, for its ubiquity, popularity and general robustness has been considered to be the “killer-app” of the Internet, that is, the application whose utility brought the Internet to the attention of the general public and provided the incentive for beginning a mass adoption of the internet as a service.

As email gained in popularity, its uses expanded and features that were not anticipated by the researchers who developed SMTP have now become desirable if not essential.

One failing in SMTP is the inability to verify the identity of the sender of an email message. So-called spoofing techniques and the use of open mail relays have allowed entities to transmit email while impersonating a sender. This impairs the trust that a recipient of an email message has in the provenance of the message, and diminishes the value of a trust-based system. Despite the ubiquity of email, these issues hamper the utility of email and could be used to reduce the evidentiary weight accorded to email messages in a judicial hearing.

A further problem with SMTP and MIME based email is that there is no robust mechanism to authenticate the content and header information of a message. A number of work around solutions have been developed, but while remedying some of these issues these work around solutions typically introduce additional complexity as well as other related issues.

To understand existing solutions, it is first important to examine how a standard MIME/SMTP mail session functions. FIG. 1 illustrates an SMTP based email exchange. User A 100 composes an email message using a standard email client A 102. Client A 102 can be any of a number of standard applications such as Apple Mail, Microsoft Outlook, Mozilla Thunderbird, or another such application. The composed message is addressed to an email address associated with user B 112, and is sent from client 102 to mail server A 104 using SMTP. Client 102 and server 104 can be integrated as is the case with web-based email platforms such as hotmail.com, Yahoo Mail, or gmail.com where the client is a web-based interface that has direct connections to the server and may not employ SMTP. The email message is then transmitted through Internet 106 to mail server B 108 which is associated with the destination email address. Email client B 110 connects to server B 108 using a standard protocol such as the Internet Message Access Protocol (IMAP) or the Post Office Protocol (POP) so that the message can be downloaded. The message is then presented to User B 112.

This implementation does not necessarily provide authentication of the sender, nor of the content of the email message. Because the content of the message cannot be verified as being the same as they were when sent, and the message cannot be authenticated as being sent by a particular user, the message can be repudiated by the sender at a later date.

A public-private encryption key based infrastructure can be employed to mitigate some of the problems associated with the system of FIG. 1. FIG. 2 illustrates one such example. User A 100 employs a secure email client A 114 and a private encryption key 116 to sign the body 122 of a message 118. The header 120 of message 118 is not signed as the message 118 is transmitted using SMTP which does not provide a field for a signature that could be used to verify the header information. The message 118 with signed message body 122 is transmitted to email server A 104 using SMTP. The message is routed through Internet 106 to email server B 108 as any message would be in the system of FIG. 1. The signed body 122 of message 118 is never inspected along the route as the infrastructure makes use of the standard MIME and SMTP protocols. Secure email client B 124 connects to email server B 108 using a standard protocol such as IMAP or POP and retrieves message 118 Secure email client B 124 makes use of the public key 126 uniquely associated with private key 116 to verify the signature of the body 122 of the received message 118. The verified message 128 is then displayed to user B 112.

One skilled in the art will appreciate that using the public key 126, user B 112 is able to determine that the message body 122 was not tampered with. The signature can include a timestamp based on the clock/calendar function of the system running secure email client A 114. The message can be repudiated by the sender, if the public-private key pair (keys 116 and 126) is not associated with User A 100 in a public manner.

To associate the key pair to User A 100, a certificate authority can bind the public key 126 to identifying, information associated with User A 100. The certificate binding public key 126 to user A 100 can be sent to user B 112 in advance so that it can be added to a key ring in secure email client B 124, User B 112 could use public key 126 to encrypt a message to User A 100, who would then use private key 116 to decrypt the message. For User B 112 to sign any message (encrypted or otherwise) User B would need a different key pair.

Although this provides a degree of authentication of the message contents and a limited degree of non-repudiation, it requires that User A 100 obtain a certificate binding key 126 to him, and requires that User B 112 have a copy of the public key 126 (and preferably the certificate) and a secure email client to verify the signature. Although this does not seem like a large burden, it only appears this way because of the limited number of parties in the illustrated transaction. If there are multiple parties, each party will be required to obtain a certificate from a certificate authority, and will be required to transmit the certificate to every other party. Specialized software to manage the ring of public keys, along with the relevant, private keys must then be used to allow automated verification. This is a cumbersome process. As the number of parties grows the number of keys required to allow verification of a message also grows. Furthermore, if the security of private key 116 is compromised, it must be revoked, which can only effectively be done if a certificate authority issued a certificate for the key. When a certificate is revoked a cumbersome process must be undertaken by any party holding the compromised key to obtain a new certified key.

A public key infrastructure (PM) employing a Certificate Authority (CA) does address a number of the issues around authenticating the integrity of a message body, but it requires a large number of changes to the email infrastructure as well as an understanding of the complex nature of a PKI. As a result of the added complexity caused, PKI has been slow to gain traction with the broader public though it has proponents in the security field.

One system that has attempted to address these issues is provided through the use of Digital Postmarks, Digital Postmarks are intended for use in an enterprise environment, and are designed to specifically provide authentication of message contents. Fundamentally it is designed as a non-repudiation service. FIG. 3 illustrates an exemplary installation of a system to use Digital Postmarking. User A 100 uses a client to generate an email message. This message is sent from a client to an outgoing mail server 130, typically provided by an enterprise associated with User A 100, Outgoing mail server 130 receives the message and forwards it to the digital postmarking server 132. Server 130 preferably signs the message prior to transmission to digital postmarking server 132 so that postmarking server 132 can verify that the message was not altered in transit. Digital postmarking server 132 then validates the authenticity of the signature against a known key associated with either user A 100 or with mail server 130. Upon successful verification, the digital postmarking server 132 generates a timestamp that, along with the message, the signature and validation results are stored in a digital postmark non-repudiation database 134. This information can then be accessed at a later date to establish a non-repudiation function. The postmarks server 132 and database 134 generate a digital postmarking receipt that is transmitted back to the outgoing mail server 130. The outgoing mail server 130 wraps the original message in the digital postmarking receipt and transmits the message to the incoming mail server 136. User B 112 retrieves the message in the proprietary digital postmarking wrapper 138 using a proprietary client 140. The client 140 can then retrieve the authentication information from the digital postmark non-repudiation database 134. Client 140 does not need to perform any verification processes on the message itself, as the verification, receipt and even the original document can be retrieved from database 134, alternately a local cryptographic verification can be performed by client 140.

Although the digital postmarking, system discussed with relation to FIG. 3 can provide both authentication of a sender and the message, it requires proprietary software, and is cumbersome. The system is designed for implementation in an enterprise environment, and does not take into account the needs of individuals. The digital postmarking server 132 is often dedicated to a particular outgoing mail server 130. As such digital postmarking server 132 requires that the enterprise obtain a dedicated hardware device and implement a complex process of having either client software sign a message or having the mail server 130 sign message prior to beginning the verification process. The storage requirements for database 134 can be immense if all messages and attachments are stored for a number of different organizations. As such, the verification information is typically only stored for a predefined period. If this period expires, the ability to authenticate the message can be adversely affected.

To provide a mechanism for secure email, without needing a proprietary infrastructure, an enhancement to the MIME standard entitled Secure/MIME. (S/MIME) has been introduced. S/MIME defines a format for a signed or encrypted message that requires that the verification information be included in the message in a particular fashion. S/MIME functionality has been incorporated into most common modern email clients as its implementation is not complex and can be used to provide authentication of the message contents using digital signatures (non-repudiation is provided if a certificate is employed) as well an encryption functionality. In operation, an S/MIME client will encrypt the message body and transmit the resulting object as a MIME attachment (specifically an application/pkcs7-mime MIME entity). One advantage of S/MIME is that standard mail servers are used, thus requiring no additional infrastructure.

For a user to make use of an S/MIME compliant client, an individual key or certificate must be obtained (preferably from a certificate authority). To encrypt a message; the recipient's public key must be known, whereas for signing, the recipient must have access to the sender's public key to allow for verification. By using a basic certificate, the only identifying information bound to the key (and thus the signed message) is an email address. To associate additional information, such as actual individual identity information, a certificate must be provided by a CA that has verified the identity information. The certificate is then typically publicly available from the CA, and at a minimum a certificate serial number is made available to allow for revocation of a certificate (as described above with respect to an encryption based mail client).

FIG. 4 illustrates an S/MIME compliant exchange. One skilled in the art will appreciate that this makes use of a PKI infrastructure, and thus bears similarity to the encryption based signature system described earlier. A user 100 employs an S/MIME compliant email client A 142, to create a digitally signed email message 144 using private key 116. The message is sent to email server A 104 using SMTP and is then routed through Internet 106 to email server B 108. The digitally signed email message 144 is retrieved by S/MIME client B 124 S/MIME client B 124 can parse message 144, which has a structure defined by the S/MIME standards. As such, if the message has been encrypted, the encrypted package is provided in the application/pkcs7-mime MIME entity. Similarly, a defined entity is used for storing the cryptographic signature used to ensure data integrity (application/(x-pkcs7-signature).

Upon generation of the signature at client 142, the public key used to sign the message is identified by the serial number and certificate issuer. This allows the recipient to retrieve the certificate to obtain the key to verify the signature. The certificate binding the user information to the key provides non-repudiation. However, it should be noted that at a later date if the certificate expires and is deleted, verification of the message can no longer be performed, reducing the archival qualities of the verification process. When a certificate expires, a new certificate is often generated, even if the same key pair is used. This often leads users to assume that the old certificate can be deleted. Recipients often delete downloaded certificates when they notice that a sender has multiple certificates, which can cause unexpected inability to verify signatures.

Because the signature is carried separate from the body of the message (in contrast to many other signature implementations) mailing list software that changes the message body often results in the invalidation of the signature. Additionally, because message attachments may be encrypted using S/MIME the ability of a server to perform scans to detect malware such as worms or virii is adversely affected. Such scanning can only performed at the client side, which is often too late in the process.

One skilled in the art will appreciate that though there are many systems for providing digital signatures on email messages to allow for verification of the integrity of the message body, they all introduce a number of different layers of complexity. Addition of authenticated time stamping functionality is difficult to provide without the addition of additional server side hardware, much as the ability to authenticate the sender of a message requires the cumbersome management of encryption keys.

It is therefore, desirable to provide a mechanism providing trusted authentication of a message and its contents.

### SUMMARY OF THE INVENTION

it is an object of the present invention to obviate or mitigate at least one disadvantage of the prior art.

In a first aspect of the present invention, there is provided a method providing trusted third party verification of an electronic message. The method comprises the steps of receiving the electronic message from a sender addressed to at least one recipient; processing the electronic message to determine a digital signature associated with both the electronic message and a publicly accessible key not associated with the sender of the electronic message; attaching the determined digital signature to the electronic message; and transmitting the electronic message with the attached digital signature to the at least one recipient.

In an embodiment of the first aspect of the present invention, the step of processing the message includes determining the digital signature by encrypting a cryptographic hash of the electronic message, possibly just the body of the electronic message, using the private portion of a private-public key pair. In another embodiment, the step of processing the electronic message can include overwriting header values such as time and date values in using verified header values (e.g. verified time and date values).

In a further embodiment of the present invention, the step of processing the electronic message includes performing a virus scan of the electronic message, and optionally removing a virus identified by the virus scan. In another embodiment, the step of processing the electronic, message can include copying header information from the electronic message into the electronic message body prior to determining the digital signature. In yet another embodiment of the first aspect of the present invention, the step of attaching the determined digital signature includes attaching the digital signature as a Secure Multipurpose Internet Mail Extensions compliant digital signature.

In another embodiment of the first aspect of the present invention, the method can further include the step of authenticating an account associated with the sender of the electronic message after receiving the electronic message authentication of the account can include receiving authentication credentials from the sender of the electronic, message and verifying the credentials against known data. The receipt of authentication credentials can include receiving login credentials from the sender in accordance to the Simple Mail Transfer Protocol Authentication standard. In another embodiment, the step of authenticating includes verifying an address in a From: field, in a header to the electronic message against a known value.

In further embodiments, the method can include billing an entity associated with the sender of the email message, and the message can be a Multipurpose Internet Mail Extensions based email message.

In a second aspect of the present invention, there is provided a trustworthy processor for providing verification of an electronic message, sent by a sender, to at least one recipient of the electronic message. The processor comprises a message interface and a signature engine. The message interface receives electronic messages from the sender and transmits messages to the at least one recipient after processing by the signature engine. The signature engine signs the received message using a signature not associated with the sender to allow the at least one recipient to verify that the message has not been altered and forwards the signed message to the at least one recipient through the message interface.

In an embodiment of the second aspect of the present invention, the message interface is a Simple Mail Transfer Protocol interface. In another embodiment of the second aspect of the present invention, the processor further includes a message processor for overwriting values in a header of the message with verified values, for copying the contents of the header into a message body prior, and for forwarding the modified message to the signature engine for signing. The message processor can also include a timestamping unit for overwriting the time and date of values in the header with verified time and date values. The message processor can also optionally include a sender verification unit for overwriting FROM values in the header with verified name and email address values.

In a further embodiment, the signature engine can include a dedicated cryptographic engine for digitally signing the message using a cryptographic key.

In another embodiment of the second aspect of the present invention, the processor further includes an account authenticator for authenticating the identity of the message sender prior to transmission of the signed message to the at least one recipient, and optionally includes a billing processor for assessing a charge to an account associated with the authenticated identity of the message sender.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein

FIG. 1 is a block diagram illustrating the data flow in a prior art messaging process;

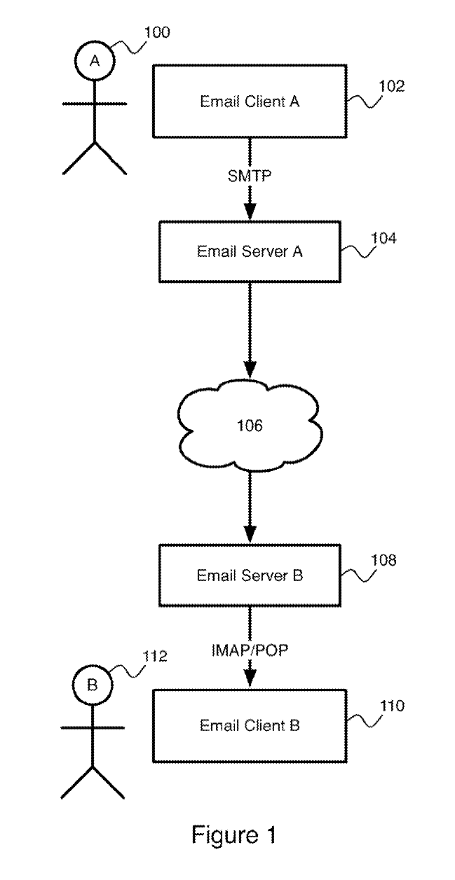

FIG. 2 illustrates the data flow in a prior art cryptographic signature based messaging process;

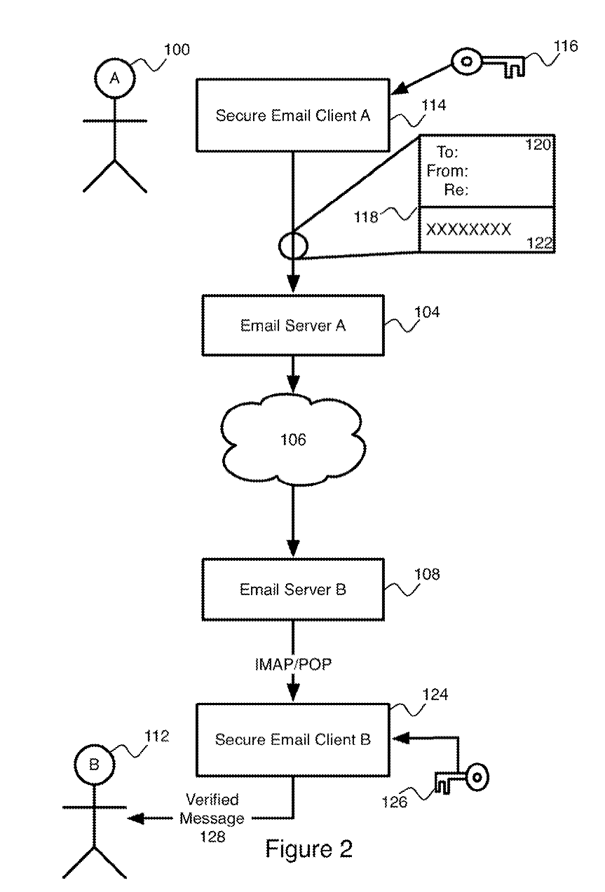

FIG. 3 illustrates the data flow in a prior art digital postmarking based messaging process;

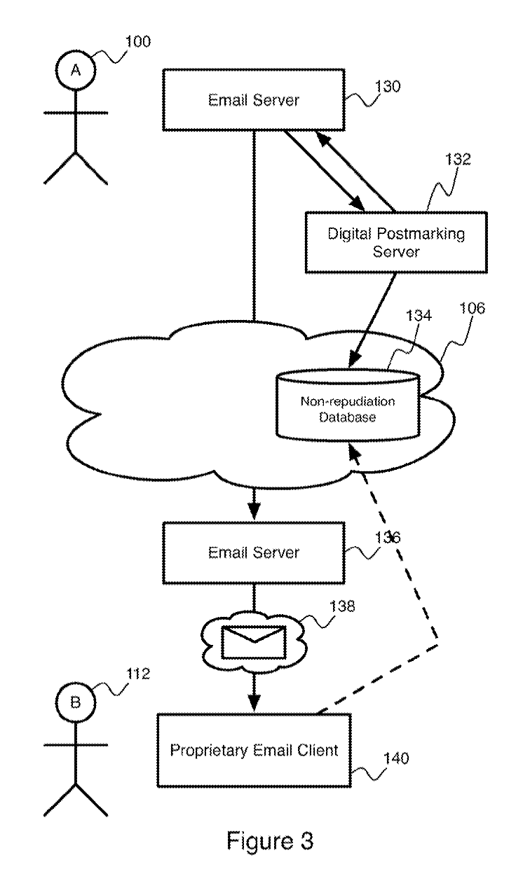

FIG. 4 illustrates the data flow in a prior art S/MIME, based messaging process;

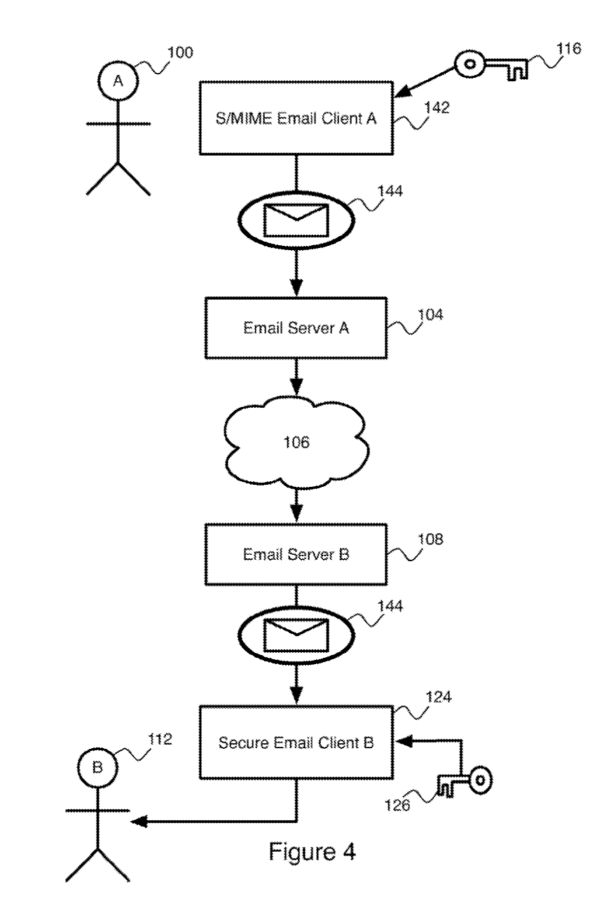

FIG. 5 is a block diagram illustrating a data flow involving trustworthy processing of electronic messaging;

FIG. 6 is a flow chart illustrating a method of trustworthy processing;

FIG. 7 is a flow chart illustrating a method of authenticating an account in a trustworthy processing method;

FIG. 8 is a flow chart illustrating a method of message processing in a trustworthy processing method;

FIG. 9 is a flowchart illustrating a method of billing in a trustworthy processing method; and

FIG. 10 is a block diagram illustrating logical elements of a trustworthy processor of the present invention.

### DETAILED DESCRIPTION

The present invention is directed to a system and method for electronic messaging with a simplified authentication and message integrity verification mechanism.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

In the present invention, the troubles associated with user management of a PKI key ring are mitigated by the use of a single digital signature for verifying the contents of messages from any of a number of different individuals. This signature is associated with a trusted third party. Instead of relying on a user to obtain a certificate from a CA, the user obtains an account with a trusted third party that processes messages and performs the signature process on behalf of the user. The recipient of the message can trust that the message was verified by the trusted third party, and that the third party performed a publicly defined authentication of the user. Thus, users do not need to obtain certificates, and recipients do not need to manage large and unwieldy key rings. Additional services such as time stamping, sender authentication and virus scanning can also be offered, Because users are authenticated prior to the signed message being transmitted to recipients, a billing process can be implemented. The authentication and optional billing also reduce the likelihood that a message is unsolicited commercial email. As a result, the messages processed by the server can be trusted to a higher degree, allowing them to bypass so-called SPAM filters. Other benefits of the present invention will be discussed below with relation to the illustration of an exemplary system and method. One skilled in the art will appreciate that the description below is intended to be exemplary in nature and should not be regarded as limiting the scope of the present invention.

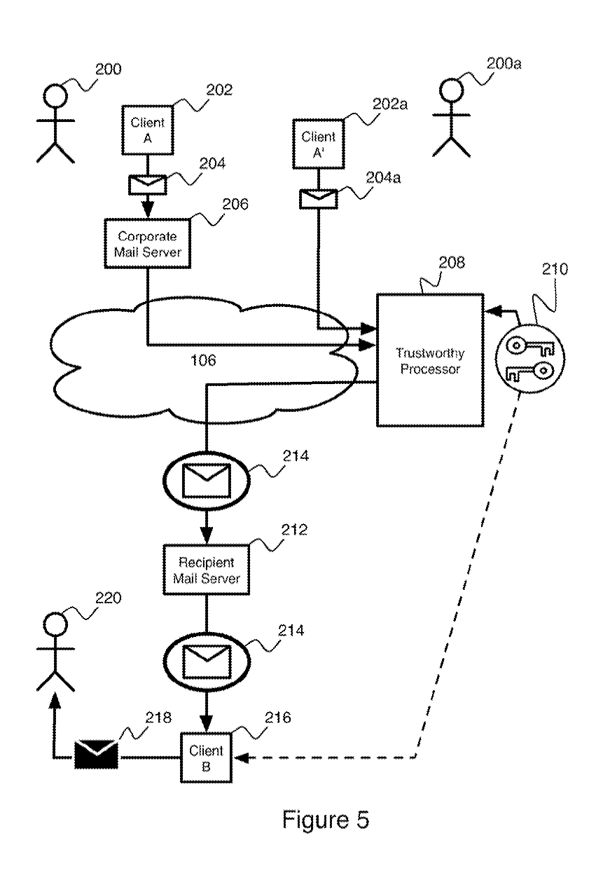

FIG. 5 illustrates an architecture in which the present invention can be implemented. Two different types of senders are considered, those in an enterprise environment, and those who do not have access to such a system. Corporate Sender 200 creates an email message 204 using client A 202. The message 204 can include attachments, but there is no requirement that attachments be appended to the message. The message is transmitted to the corporate mail server 206. Sender 200 is authenticated by corporate mail server 206. The message can either be flagged for sending as conventional email, or it can be flagged to be sent as a trusted third party signed message. The flagging of the message can be done at the client 202, or using corporate rules enforced by server 206. When a message is to be signed by the trusted third party, it is routed from server 206 to a trustworthy processor 208.

To provide service to individual users, the present invention can be accessed by individual users much as any other mail server would be used. An individual sender 200a composes a message 204a on client A' 202a. When the message is to be sent, it is relayed to trustworthy processor 208 through Internet 106. Connections to trustworthy processor 208 from either client A or from server 206 can be made using a conventional protocol such as SMTP with Transport Layer Security (TLS) for enhanced confidentiality and integrity of communication with the trustworthy processor 208 if so desired. This allows for existing infrastructure to be used without requiring either individuals or enterprises to update their software or hardware. One skilled in the art will appreciate that Client A′ 202a can be a web-based mail client without departing from the scope of the present invention.

Trustworthy processor 208 can perform a number of different processes on received messages, it preferably begins by authenticating the party initiating the session. In the case of an individual user, such as sender 200a, the authentication can be done using standard techniques such as SMTP-Auth or POP before SMTP. In the case of enterprise access, the enterprise server 206 can be authenticated using any of a number of known techniques. The users of enterprise mail server 206 are authenticated by server 206, and the server authentication of the user can then be passed along to trustworthy processor 208 en lieu of individual authentications.

Authentication of a user is done so that the trustworthy processor can provide user authentication and non-repudiation. After authenticating the user, the trustworthy processor can ensure that the message header includes the correct information associated with the user account. The header information can optionally be copied into the body of the email so that it is signed. In conventional systems, the body of the email message is the only portion of the message that is signed. This is done to allow the message to be easily routed using the existing SMTP infrastructure; however, it causes the drawback that the sender and recipient information is not signed. By copying header information into the body of the message, it can be signed along with the message body. The trustworthy processor 208 then signs the message, preferably using a standard based format, such as S/MIME, using the private portion of the postmarking key pair 210. The signed message is then transmitted to the addresses recipients, and is received by recipient mail server 212. The signed message 214 is retrieved by SWINE email client B 216. The signed message 214 can be verified by client B 216 using the public portion of the postmark key pair 210. The verified message 218 can then be displayed to the recipient 220, Before digitally signing message 204 or 204a, trustworthy processor 208 can modify the message body to add in additional content including branding information designed to provide an immediate symbol that recipients can associate with an assurance that the message was signed by a trusted third party.

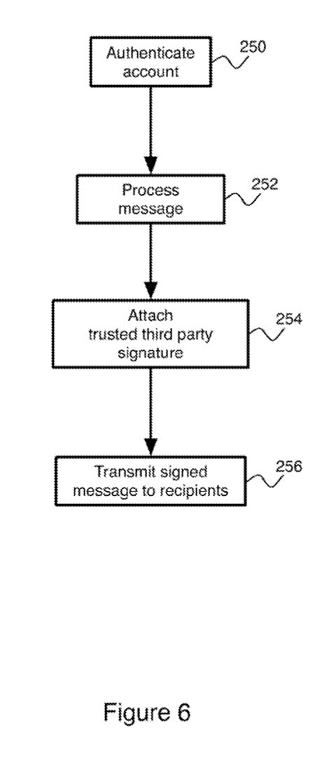

FIG. 6 is a flowchart illustrating a method of the present invention carried out by a trustworthy processor. The process starts when the processor receives a mail message for processing. The user account is authenticated in step 250. Upon successful authentication of the user, the message is processed in step 252. This processing step can include value added functionality, but also includes the determination of a digital signature based on the con ent of the received message. The trusted third party signature determined in step 252 is attached to the message in step 254. This is preferably done in compliance with the format defined in the S/MIME standard. In the final step of the process, the message is transmitted to the addressed recipients.

In contrast to prior art methods, the signature applied is the signature of a trusted third party, not the signature of the sender. By making use of existing infrastructure, such as the S/MIME infrastructure, the present invention can provide a form of user authentication, message integrity verification and time stamping without requiring additional hardware installed in an enterprise, and without requiring users to make use of proprietary email clients to read or compose email.

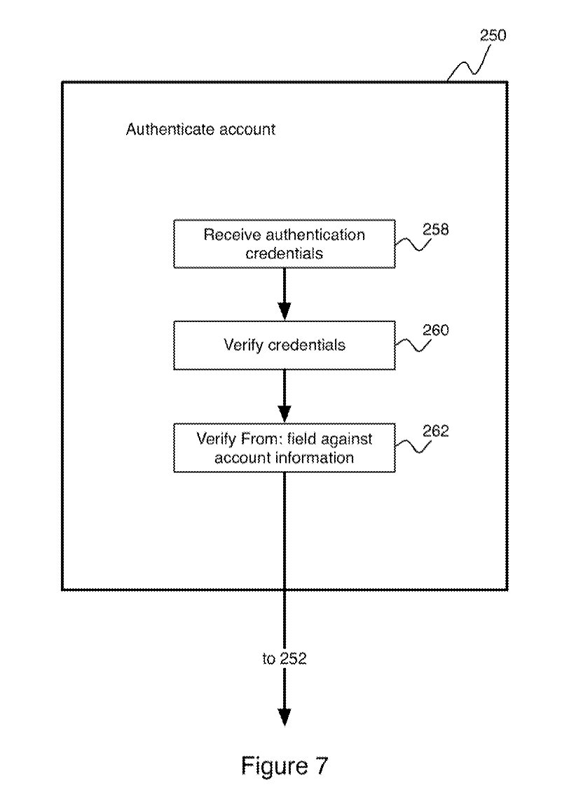

In FIG. 6, the first step is authenticating the account associated with an incoming message 250. The authentication of an account can be carried out using a number of optional steps a illustrated in the flow chart of FIG. 7. In step 258, the authentication credentials are received, and they are verified in step 260. This can be done by having the trustworthy processor make use of standard authentication mechanisms such as SMTP-Auth or POP before SMTP. Other authentication techniques can be employed, especially where the connection is received from an enterprise mail server. When an enterprise server connects, it can do so on behalf of an individual user, or can do so on behalf of the enterprise, with the trustworthy processor identifying individual information on the basis of the email address of the From: field in the message.

The trustworthy processor may also elect to verify the From: field, against addresses associated with the verified authentication credentials. If the From: field is not verified, the processor can generate an error message, or optionally it can overwrite the From: field in the message. By performing a verification of the From: field, a further security barrier is provided, which can be important if the processor is intended to be able to authenticate the sender information.

Upon finishing any or all of these steps, the process continues to step 252.

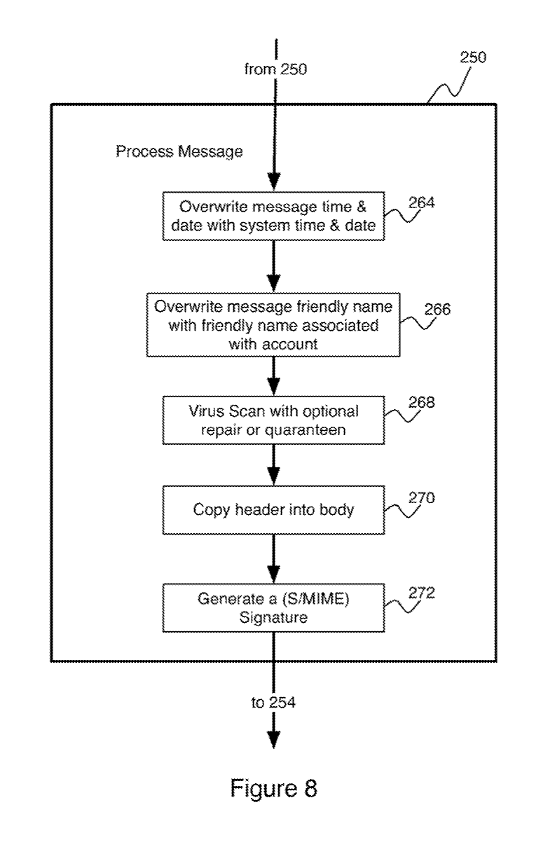

A breakdown of optional steps in the processing of the message in step 252 is provided in the flowchart of FIG. 8. One skilled in the art will appreciate that a number of these steps are optional as they provide added value to the system and method of the present invention, but are not essential for the operation of the system. After completing step 250, the time and date associated with the message can be overwritten in step 264. This effectively embeds a timestamp in the message header that can be trusted by the recipient. The From Name field in the message can be overwritten with a name associated with the account if it does not match in step 266. In one simplified implementation, regardless of the From name field value, the name is overwritten to ensure that all messages are handled in the same fashion in step 268 a virus scan of the message contents and any attachments can be performed. By performing this scan, malware and inappropriate content can be identified and removed, or the message can be rejected and the user informed of a problem. By performing the scan before signing the message, the signature will still be valid. Server side scanning at either the sender or recipient mail server in prior art implementations results in invalidating the signature if virii are to be removed when identified, which defeats the purpose of providing authenticated email.

In step 270, the header information of the message is copied into the body of the message. This allows the To: From: Date: and Subject: information, along with other header information, to be incorporated into the body of the message before it is signed. Because earlier processes allow for the overwriting of name fields, time and date values and other information to ensure that they are accurate, this information can be signed along with the message body. This allows the recipient to archive the message and have non-repudiable evidence as to when a message was sent, who sent it and what it contained, without needing to consult an external archive. The verification can be guaranteed so long as access to the certificate of the trustworthy processor is available.

In step 272, a digital signature is generated using a private key associated with a public key stored in a publicly available certificate. The signature can be generated using conventional processes used over the entire message body. This digital signature is the trusted third party signature attached in step 254.

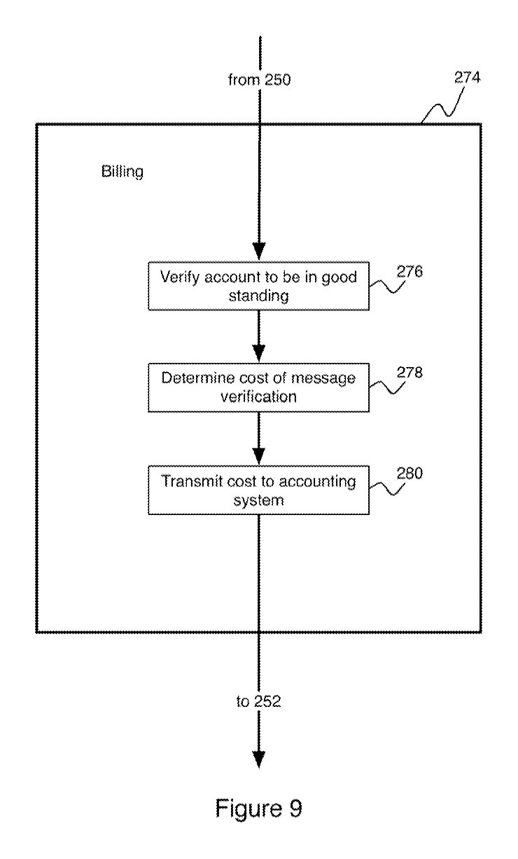

Because the sender information is verified before the message is transmitted to the addressed recipients, a billing process can be added to the method illustrated in FIG. 6. One such process is illustrated in the flowchart of FIG. 9. After the account verification process, the billing information associated with account is processed as illustrated in step 274. A number of different implementations of a billing process can be employed. For exemplary purposes, a method is illustrated in FIG. 9. In this exemplary method, the account is verified as being in good standing in step 276. The cost of the message verification and signature is determined in step 278 and is transmitted to the accounting system in step 280. The process may require a response from the accounting system before proceeding if it is based on prepaid credits, or can be allowed to immediately proceed in other cases. The determination of the cost can be done using any of a number of different models, including either flat rate billing systems that bill a fixed amount per message, or a per-byte charge that is determined based on the size of the message. The specific implementation can be varied without departing from the scope of the present invention.

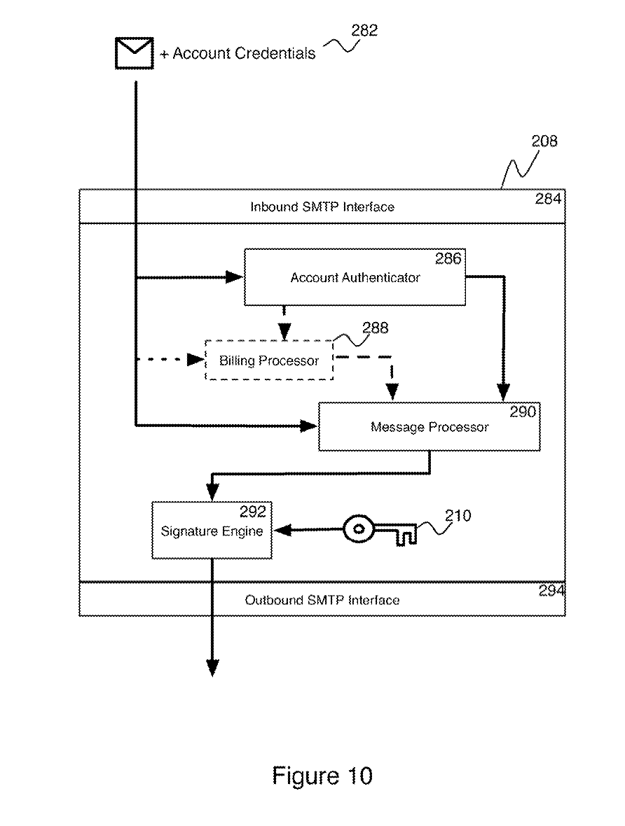

FIG. 10 is a block diagram illustrating an implementation of the system of the present invention as functional elements. One skilled in the art will appreciate that the function of a particular element can be spread across a number of other logical elements, or two or more logical elements illustrated in this diagram could be combined in one logical unit. The trustworthy processor 208 receives communications 282 from clients (either directly or through a registered enterprise server) that contain both mail messages and account credentials. The communications are received by an inbound mail interface, such as the illustrated inbound SMTP interface 284. The account credentials are forwarded to the account authenticator 286 and to the optional billing processor 288 if present. The account authenticator 286 authenticates the communication as being from a valid user account using any of a number of known techniques including those discussed above. The mail message is provided to both the billing processor 288 if present and the message processor 290. The billing processor 288 can be used to determine if a valid account is in arrears before a message is processed. It also can be used to determine the cost associated with handling each received message. The billing processor 288 can be in communication with an accounting system (not shown) so that accurate billing information can be recorded and invoiced. The message processor 290 processes the message after receiving the go ahead from both the account authenticator 286 and the billing processor 288. The message processor is not essential and can be omitted if the sole function of trustworthy processor is to obtain a trusted third party verification of the message contents. If added value services including time stamping, non-repudiable authentication of the message sender, virus scanning and embedding of the header in the message body are to be provided they can be provided by the message processor 290. After the message processor 290 (or directly from the inbound SMTP Interface) the message is provided to the signature engine 292 which uses the private portion of the postmarking key pair 210 to generate a signature that can be used to verify the contents of the message body. This signature is preferably handled in accordance with the S/MIME standards when attached to the message. Signature engine can be a general purpose processor, or can optionally include a specific cryptographic engine designed for computing cryptographic signatures of messages using key 210. The signed message is then provided to outbound SMTP interface 294 which transmits the message to the addressed parties.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, chemical, or electrical storage medium including a diskette, compact disk read only memory (CD-ROM), digital versatile disc read only memory (DVD ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of providing, trusted third party verification of an electronic message comprising:
receiving the electronic message from a sender addressed to at least one recipient;
processing the electronic message to determine a digital signature associated with both the electronic message and a publicly accessible key not associated with the sender of the electronic message;
attaching the determined digital signature to the electronic message; and
transmitting the electronic, message with the attached digital signature to the at least one recipient.

2. The method of claim 1 wherein the step of processing the message includes determining the digital signature by encrypting a cryptographic hash of the electronic message using the private portion of a private-public key pair.

3. The method of claim 2 wherein the digital signature is a cryptographic digital signature of the body of the electronic message.

4. The method of claim 1 wherein the step of processing the electronic message includes overwriting values in a header to the electronic message with verified values.

5. The method of claim 4 wherein overwriting values in the header includes overwriting time and date values in the header using verified time and date values.

6. The method of claim 1 wherein the step of processing the electronic message includes performing a virus scan of the electronic message.

7. The method of claim 6 further including the step of removing a virus identified by the virus scan.

8. The method of claim 1 wherein the step of processing the electronic message includes copying header information from the electronic message into the electronic message body prior to determining the digital signature.

9. The method of claim 1 wherein the step of attaching the determined digital signature includes attaching, the digital signature as a Secure Multipurpose Internet Mail Extensions compliant digital signature.

10. The method of claim 1 further including a step of authenticating an account associated with the sender of the electronic message after receiving the electronic message.

11. The method of claim 10 wherein the step of authenticating the account includes receiving authentication credentials from the sender of the electronic message and verifying the credentials against known data.

12. The method of claim 11 wherein the step of receiving authentication credentials includes receiving login credentials from the sender in accordance to the Simple Mail Transfer Protocol Authentication standard.

13. The method of claim 10 wherein the step of authenticating includes verifying an address in a From: field in a header to the electronic message against a known value.

14. The method of claim 1 further including billing an entity associated with the sender of the email message.

15. The method of claim 1 wherein the electronic message is a Multipurpose Internet Mail Extensions based email message.

16. A trustworthy processor for providing verification of an electronic message, sent by a sender, to at least one recipient of the electronic message, the processor comprising:
a message interface for receiving the electronic message from the sender; and
a signature engine for signing the received message using a signature not associated with the sender to allow the at least one recipient to verify that the message has not been altered, and for forwarding the signed message to the at least one recipient through the message interface.

17. The processor of claim 16 wherein the message interface is a Simple Mail Transfer Protocol interface.

18. The processor of claim 16 further including a message processor for overwriting values in a header of the message with verified values, for copying the contents of the header into a message body prior, and tai forwarding the modified message to the signature engine for signing.

19. The processor of claim 18 wherein the message processor includes a timestamping unit for overwriting time and date values in the header with verified time and values.

20. The processor of claim 18 wherein the message processor includes a sender verification unit for overwriting FROM values in the header with verified name and email address values.

21. The processor of claim 16 wherein the signature engine includes a dedicated cryptographic engine for digitally signing the message using a cryptographic key.

22. The processor of claim 16 further including an account authenticator for authenticating the identity of the message sender prior to transmission of the signed message to the at least one recipient.

23. The processor of claim 22 further including, a billing processor for assessing a charge to an account associated with the authenticated identity of the message sender.
